(19) United States
(12) Patent Application Publication
(10) Pub. No.: US 2022/0005336 A1
(43) Pub. Date: Jan. 6, 2022

(54) INFORMATION PROCESSING SYSTEM, INFORMATION PROCESSING APPARATUS, AND INFORMATION PROCESSING METHOD

(71) Applicant: TOYOTA JIDOSHA KABUSHIKI KAISHA, Toyota-shi (JP)

(72) Inventors: Yurika TANAKA, Yokosuka-shi (JP); Shuichi SAWADA, Nagoya-shi (JP); Takaharu UENO, Nagoya-shi (JP); Shin SAKURADA, Toyota-shi (JP); Daiki YOKOYAMA, Gotemba-shi (JP); Genshi KUNO, Kasugai-shi (JP)

(73) Assignee: TOYOTA JIDOSHA KABUSHIKI KAISHA, Toyota-shi (JP)

(21) Appl. No.: 17/357,207

(22) Filed: Jun. 24, 2021

(30) Foreign Application Priority Data
Jul. 2, 2020 (JP) 2020-115047

(51) Int. Cl. G08B 21/02; G06K 9/00; G06T 7/70

(52) U.S. Cl. CPC G08B 21/0266; G08B 21/0233; G06T 2207/30201; G06K 9/00255; G06T 7/70; G08B 21/025

(57) ABSTRACT

An information processing system disclosed includes a controller. When the controller detects that a first user and a second user have been separated to become lost to each other in a specific area, it determines the location of the first user using data that links the first user and the second user and images captured by a plurality of cameras provided in the specific area. Then, the controller executes the processing of providing an entertainment to the first user at the determined location of the first user and providing information about the determined location of the first user to the second user.

### CROSS-REFERENCE TO RELATED APPLICATIONS

This application claims the benefit of Japanese Patent Application No. 2020-115047, filed on Jul. 2, 2020, which is hereby incorporated by reference herein in its entirety.

### BACKGROUND

### Technical Field

The present disclosure relates to an information processing system, an information processing apparatus, and an information processing method.

### Description of the Related Art

It is known in a prior art to detect a difference in the paths of move of a parent and a child using image information acquired by a surveillance camera to detect child's getting lost and give a warning (see, for example, Patent Literature 1 in the citation list below).

Patent Literature 2 in the citation list teaches to extract information about a parent and a child from an image of them captured upon their entrance into a certain facility and store the information in a parent-child database. Examples of such information include information about the color of the parent's clothes, information about the color of the child's clothes, and information about the height of the child. When the child becomes missing in the facility, information about the color of the parent's clothes, information about the color of the child's clothes, and information about the height of the child are sent from a parent's terminal to a server. In response to this, the server sends a course guidance from the location of the parent to the location of the child to the parent's terminal.

### CITATION LIST

### Patent Literature

Patent Literature 1: Japanese Patent No. 6350024

Patent Literature 2: Japanese Patent Application Laid-Open No. 2013-191059

### SUMMARY

An object of this disclosure is to provide a technology that can help a person (e.g. a child) and another person accompanying him/her who have been separated to become lost to each other to meet again efficiently.

Disclosed herein is an information processing system. The information processing system may comprise, for example:

a plurality of cameras provided in a specific area;

a storage device that stores data that links a first user and a second user accompanying the first user who are in the specific area;

a controller including at least one processor and executing the processing of detecting that the first user and the second user have been separated to become lost to each other, determining the location of the first user using images captured by the plurality of cameras and data stored in the storage device, providing an entertainment to the first user at the location determined by the above processing, and providing location information to the second user, the location information being information about the location determined by the above processing.

Also disclosed herein is an information processing apparatus. The information processing apparatus may comprise, for example:

a storage device that stores data that links a first user and a second user accompanying the first user who are in a specific area;

a controller including at least one processor and executing the processing of detecting that the first user and the second user have been separated to become lost to each other, determining the location of the first user using images captured by a plurality of cameras provided in the specific area and data stored in the storage device, providing an entertainment to the first user at the location determined by the above processing, and providing location information to the second user, the location information being information about the location determined by the above processing.

Also disclosed herein is an information processing method. The information processing method may comprise, for example, the following steps of processing executed by a computer:

detecting that a first user and a second user accompanying the first user who are in a specific area have been separated to become lost to each other;

obtaining data that links the first user and the second user;

determining the location of the first user using images captured by a plurality of cameras provided in the specific area and the data that links the first user and the second user;

providing an entertainment to the first user at the location determined in the above step; and

providing location information to the second user, the location information being information about the location determined in the above step.

Also disclosed herein is an information processing program for implementing the above-described information processing method and a non-transitory storage medium in which this information processing program is stored.

This disclosure provides a technology that can help a person (e.g. a child) and another person accompanying him/her who have been separated to become lost to each other to meet again efficiently.

### BRIEF DESCRIPTION OF DRAWINGS

FIG. 1 is a diagram illustrating the general configuration of a user search system to which the technology disclosed herein is applied.

FIG. 2 is an exemplary arrangement of cameras and signage apparatuses in a specific area.

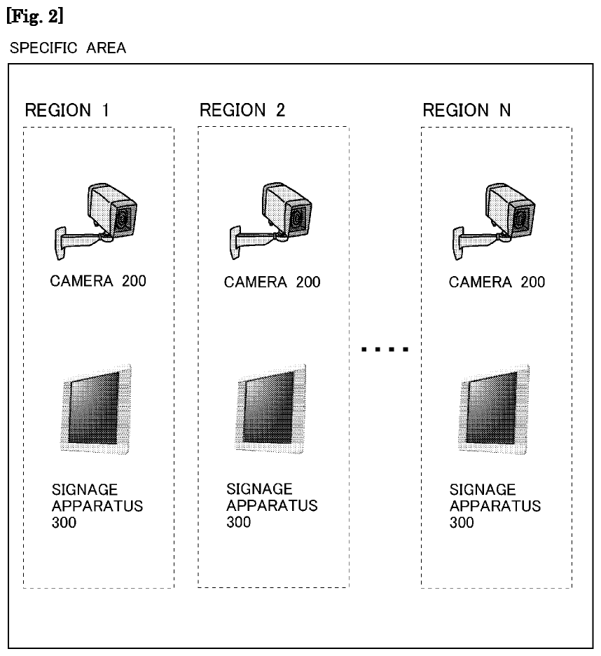

FIG. 3 is a block diagram illustrating an exemplary configuration of a server apparatus included in the user search system.

FIG. 4 illustrates an exemplary structure of a user information table stored in a user management database.

FIG. 5 is a flow chart of a process executed by a server apparatus according to an embodiment.

### DESCRIPTION OF EMBODIMENTS

The technology disclosed herein is applied to a system for searching for a first user who has been separated from a second user to become lost in a certain area, such as a store, a facility, or a town. The first user referred to in this disclosure is a user who needs to be accompanied by someone when going out of the home. An example of the first user is a child. The second user is a user who accompanies the first user when the first user goes out of the home. Examples of the second user include a parent, a relative, a childcare worker, and a teacher.

When the first user is accidentally separated from the second user to become lost in a certain area, one possible measure to be taken is determining the location of the first user using a plurality of cameras (e.g. surveillance cameras) provided in that area and informs the second user of the location of the first user thus determined. It is possible to determine the location of the first user efficiently and quickly by this method. Moreover, it is possible to determine the location of the first user even when the number of available persons who can be engaged in search for the first user is small. However, the first user does not always continue to stay at the determined location, but he or she may continue to move, looking for the second user in some cases. In such cases, it may be difficult to help the first user and the second user to meet quickly.

The information processing system disclosed herein provides a countermeasure to the above problem. Specifically, after determining the location of the first user who has been separated from the second user, the information processing system disclosed herein provides an entertainment to the first user at that location to prevent the first user from moving uselessly. This information processing system includes a controller. The controller firstly executes the processing of detecting that the first user and the second user have been separated to become lost to each other. For example, the controller may detect that the first user is not present within a predetermined distance from the second user using images captured by a plurality of cameras provided in a specific area. In other words, the controller may detect that the first user and the second user have been separated to become lost to each other by the absence of the first user within the predetermined distance from the second user. In this connection, data that links the first user and the second user may be stored in a storage device so that the controller can determine whether the first user is present within the predetermined distance from the second user. The data that links the first user and the second user may be, for example, data that links features of the first user and the second user in terms of their appearances (e.g. their genders, ages, heights, or clothes). Alternatively, the data that links the first user and the second user may be data that links face recognition data of them.

There may be cases where the first user and the second user temporarily separate from each other intentionally with mutual consent. In view of such cases, the controller may detect that the first user and the second user have been separated to become lost to each other by the continuous absence of the first user within the predetermined distance from the second user longer than a predetermined length of time. Alternatively, the controller may detect that the first user and the second user have been separated to become lost to each other by reception of a request for search for the first user made by the second user.

When detecting that the first user and the second user have been separated to become lost to each other, the controller determines the location of the first user using images captured by the plurality of cameras provided in the specific area and data stored in the storage device. For example, the controller may pick up an image in which a user that matches the data of the first user stored in the storage device (e.g. data relating to a feature of the first user in terms of his/her appearance or face recognition data of the first user) appears from among images captured by the plurality of cameras. Then, the controller may determine the location of the first user on the basis of the location at which the camera that captured the image in which the first user appears and its image-capturing angle.

After determining the location of the first user, the controller executes the processing of providing an entertainment for the first user at the determined location. For example, the controller may cause a signage apparatus provided at a location near the first user to output a digital content (e.g. an animation video, a video game, or the like) that meets the preferences of the first user. Alternatively, the controller may cause an autonomously-movable play machine (e.g. an autonomously-movable robot imitating a character of an animation or an animal, or a ride) to move to the determined location of the first user. The storage device may store information about an entertainment that the first user likes (which will also be referred to as “preferences information”) and link it with the data that links the first user and the second user. In that case, the controller may determine an entertainment to be provided to the first user on the basis of the preferences information stored in the storage device.

After determining the location of the first user, the controller executes the processing of sending location information about the determined location to the second user. If the second user has a user's terminal, such as a smartphone, the controller may send the location information to the user's terminal. Alternatively, the controller may have a clerk or the like present near the first user provide the location information to the second user. Alternatively, the controller may provide the location information through a signage apparatus provided at a location near the second user. In the processing of providing the location information to the second user, the controller may provide an image of the first user enjoying an entertainment provided to him/her among images captured by the plurality of cameras to the second user together with the location information.

When the first user has been separated from the second user to become lost, the information processing system disclosed herein can determine the location of the first user efficiently and quickly without human efforts. Moreover, the information processing system disclosed herein can prevent the first user from moving uselessly by providing an entertainment to the first user at the determined location of the first user. Thus, the information processing apparatus can help the first user and the second user to meet again quickly.

### Embodiment

In the following, a specific embodiment of the technology disclosed herein will be described with reference to the drawings. It should be understood that the dimensions, materials, shapes, relative arrangements, and other features of the components that will be described in connection with the embodiment are not intended to limit the technical scope of the disclosure only to them, unless otherwise stated.

What is described in the following as an embodiment is a case where the technology disclosed herein is applied to a system for searching for a user (first user) who has been separated from an accompanying person (second user) to become lost in a specific area. This system will also be referred to as the “user search system” hereinafter.

(Outline of User Search System)

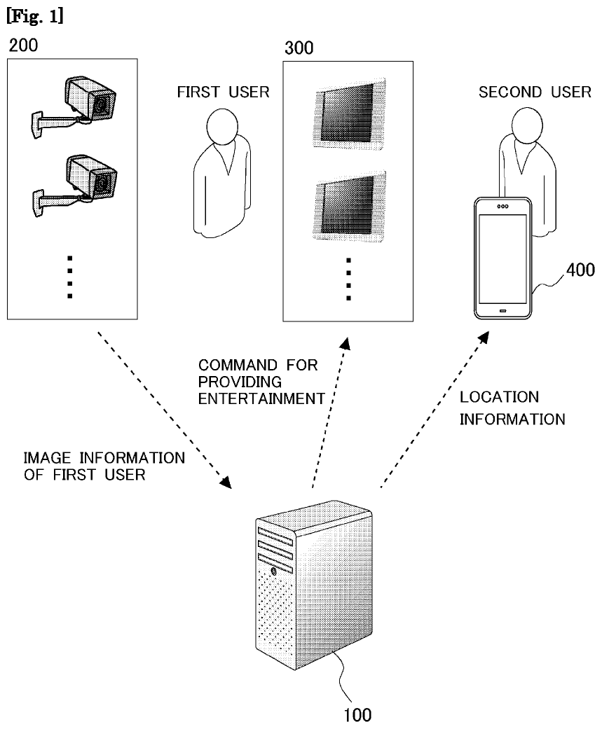

FIG. 1 is a diagram illustrating the general configuration of the user search system according to the embodiment. The user search system according to the embodiment includes a server apparatus 100, cameras 200, signage apparatuses 300, and a user's terminal 400.

The cameras 200 are surveillance cameras that capture images of places in a specific area where people (or users) can be present. In the case of this embodiment, places in the specific area where users can be present are divided into N regions including the region #1 to region #N, and at least one camera 200 is provided for each region. The size and the shape of each of the regions #1 to #N may be determined in such a way that an image of the entirety of each region can be captured by one camera. A plurality of cameras having different image-capturing angles or image-capturing locations may be provided in each region. The images captured by the cameras 200 may be sent to the server apparatus 100 either on the real time basis or at certain intervals (e.g. several seconds or several tens seconds)

The signage apparatus 300 is an apparatus that displays graphics or texts, such as electronic advertisements or a guide map of the specific area. In the case of this embodiment, at least one signage apparatus 300 is provided in each of the regions #1 to #N. The signage apparatus 300 also has the function of providing to the first user who has been separated from the second user to become lost a digital content that meets the preferences of the first user. The signage apparatus 300 provides such a digital content in response to a request made by the server apparatus 100.

The user's terminal 400 is a small computer that the second user carries. The user's terminal 400 may be, for example, a smartphone, a cellular phone, a tablet computer, a wearable computer (e.g. a smartwatch) or the like. In the illustrative case of this embodiment, the user's terminal 400 also has the function of providing information about the determined location of the first user (or location information) to the second user, when it receives the location information from the server apparatus 100. For example, the user's terminal 400 displays an image indicating the determined location of the first user on its display or outputs a voice message specifying the determined location of the first user from its speaker.

The server apparatus 100 is an information processing apparatus that helps the first user and the second user to meet again, when the first user and the second user have been separated to become lost to each other. The server apparatus 100 monitors images captured by the cameras 200 to detect that the first user have been separated from the second user (to become lost to each other). The method of this detection will be specifically described later. If separation of the first user from the second user is detected, the server apparatus 100 determines the location of the first user and executes the processing for making the first user stay at the location determined as above. Specifically, the server apparatus 100 of this embodiment provides an entertainment that meets the preferences of the first user using a signage apparatus 300 provided in the region in which the determined location of the first user falls. For example, the server apparatus 100 may cause the signage apparatus 300 to display an animation in which a character the first user likes appears. In the case where the signage apparatus 300 has the function as a video game machine, the server apparatus 100 may cause the signage apparatus 300 to execute video game software that the first user likes. The server apparatus 100 of this embodiment also has the function of informing the second user of the location of the first user determined as above. For example, the server apparatus 100 sends information indicating the determined location of the first user (i.e. location information) to the user's terminal 400 of the second user.

(Server Apparatus 100)

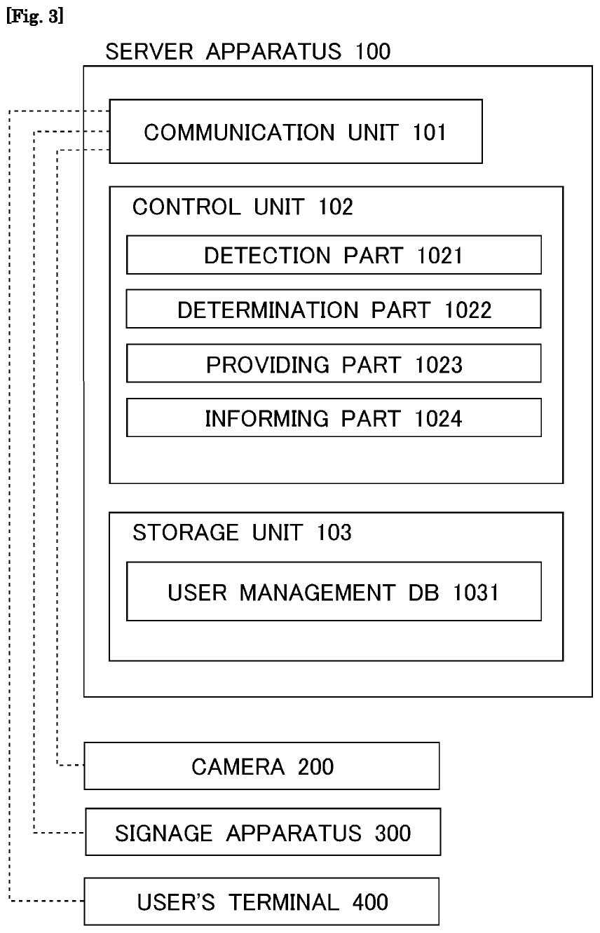

The configuration of the server apparatus 100 included in the user search system illustrated in FIG. 1 will now be described with reference to FIG. 3. FIG. 3 is a block diagram illustrating an exemplary configuration of the server apparatus 100 illustrated in FIG. 1.

As described above, the server apparatus 100 is an information processing apparatus that helps the first user and the second user to meet again, when the first user and the second user have been separated to become lost to each other. The server apparatus 100 may be constituted by a general-purpose computer. For example, the server apparatus 100 includes a processor, such as a CPU or a GPU, a main storage unit, such as a RAM or a ROM, and an auxiliary storage unit, such as an EPROM, a hard disk drive, or a removable medium. The removable medium may be a recording medium, such as a USB memory, a CD, or a DVD. The auxiliary storage unit stores an operating system (OS), various programs, and various tables. The processor executes a program(s) stored in the auxiliary storage unit to implement functions for achieving desired purposes that will be described later. Some or all the functions of the server apparatus 100 may be implemented by a hardware circuit(s), such as an ASIC or an FPGA.

As illustrated in FIG. 3, the server apparatus 100 of this embodiment includes a communication unit 101, a control unit 102, and a storage unit 103. The configuration of the server apparatus 100 is not limited to that illustrated in FIG. 3, but some components may be eliminated, replaced by other components, or added fitly.

The communication unit 101 connects the server apparatus 100 to a network. For example, the communication unit 101 communicates with the cameras 200 or the signage apparatus 300 via the network using a communication network, such as LAN (Local Area Network), WAN (Wide Area Network), or Wi-Fi (registered trademark). The communication unit 101 may communicate with the user's terminal 400 of the second user using a mobile communication service, such as 5G (5th Generation) mobile communications or LTE (Long Term Evolution) mobile communications, or a wireless communication network, such as Wi-Fi.

The control unit 102 is constituted by a processor, such as a CPU, and performs overall control of the server apparatus 100. The control unit 102 in the system of this embodiment has, as functional modules, a detection part 1021, a determination part 1022, a providing part 1023, and an informing part 1024. The control unit 102 implements these functional modules by executing a program stored in the storage unit 103 by the processor.

The detection part 1021 detects separation of the first user and the second user from each other in the specific area. Specifically, the detection part 1021 finds an image in which the second user appears (which will also be referred to as the “first image” hereinafter) from among images captured by the cameras 200 provided in the aforementioned regions. The processing of determining the first image is carried out using data stored in the storage unit 103 (e.g. face recognition data of the second user), which will be specifically described later. After finding the first image, the detection part 1021 determines, based on the first image and an image/images of a region/regions adjacent to the subject region of the first image, whether or not the first user appears within a predetermined distance from the second user. The image/images of the adjacent region/regions will also be referred to as the “related image/images” hereinafter. For example, the determination part 1021 firstly crops out an image of the area within the predetermined distance from the second user (i.e. an image of the circular area having a radius equal to the predetermined distance from the second user at the center) from the first image and the related image/images. Then, the determination part 1021 determines whether or not the first user appears in this cropped-out image. This determination process is carried out using data stored in the storage unit 103 (e.g. face recognition data of the first user), which will be specifically described later. If the first user does not appear in the cropped-out image, it is determined that the first user and the second user have been separated (to become lost to each other). On the other hand, if the first user appears in the cropped-out image, it is determined that the first user and the second user have not been separated.

In the above process, the detection part 1021 may determine that the first user and the second user have been separated on condition that the absence of the first user from the cropped-out image continues for longer than a predetermined length of time. This method can distinguish between cases where the first user and the second user temporarily separate from each other by a distance larger than the predetermined distance intentionally with mutual consent and cases where the first user and the second user are separated from each other by a distance larger than the predetermined distance inadvertently without mutual consent.

When separation of the first user and the second user is detected, in other words, when it is detected that the first user and the second user have been separated to become lost to each other, the determination part 1022 determines the location of the first user. Specifically, the determination part 1022 picks up an image in which the first user appears (which will also be referred to as the “second image” hereinafter) from among images captured by the cameras 200 provided in the respective regions. The processing of picking up the second image is performed using data stored in the storage unit 103 (e.g. face recognition data of the first user). After picking up the second image, the determination part 1022 designates the region in which the camera that captured the second image is provided (which will be referred to as the “subject region of the second image”) as the location of the first user. The determination part 1022 may also designate something in that region located near the first user that can serve as a landmark (e.g. a building, a signboard, or a display) in addition to the subject region of the second image.

The providing part 1023 executes the processing of providing an entertainment to the first user on the basis of the location of the first user determined by the determination part 1022. Specifically, the providing part 1023 firstly determines an entertainment that meets the preferences of the first user. The processing of determining such an entertainment is executed based on data stored in the storage unit 103 (e.g. information about the preferences of the first user). For example, if the first user likes a certain character in an animation, the providing part 1023 selects a video in which this character appears as the entertainment that meets the preferences of the first user. If the first user likes a certain video game, the providing part 1023 selects this video game as the entertainment that meets the preferences of the first user. After determining the entertainment that meets the preferences of the first user, the providing part 1023 sends a “provision command” to a signage apparatus 300 provided in the region in which the determined location of the first user falls The provision command is, for example, a command for causing the signage apparatus 300 to provide the entertainment determined as above to the first user. In causing the signage apparatus 300 to provide the entertainment, the providing part 1023 may cause the signage apparatus 300 to display a message requesting the first user to stay at the determined location until the second user comes to meet the first user.

The informing part 1024 informs the second user of the location of the first user determined by the determination part 1022. Specifically, the informing part 1024 firstly creates location information including information specifying the subject region of the second image (and information designating something in the subject region that can serve as a landmark located near the first user in some cases). Then, the informing part 1024 sends the location information thus created to the user's terminal 400 of the second user through the communication unit 101. The informing part 1024 sends the location information using data stored in the storage unit 103 (e.g. the mail address of the user's terminal 400). The aforementioned location information may contain an image of the first user captured by the system while he or she is enjoying the entertainment. This allows the second user to ascertain that the user determined by the server apparatus 100 is surely the first user and to see the situation about the first user.

The storage unit 103 stores various information. The storage unit 103 is constituted by a storage medium, such as a RAM, a magnetic disk, or a flash memory. What is stored in the storage unit 103 includes various programs executed by the processor and various data. In the system according to this embodiment, a user management database 1031 is constructed in the storage unit 103. The user management database 1031 is constructed by managing data stored in the auxiliary storage unit by a database management system program (DBMS program) executed by the processor. The user management database 1031 is, for example, a relational database.

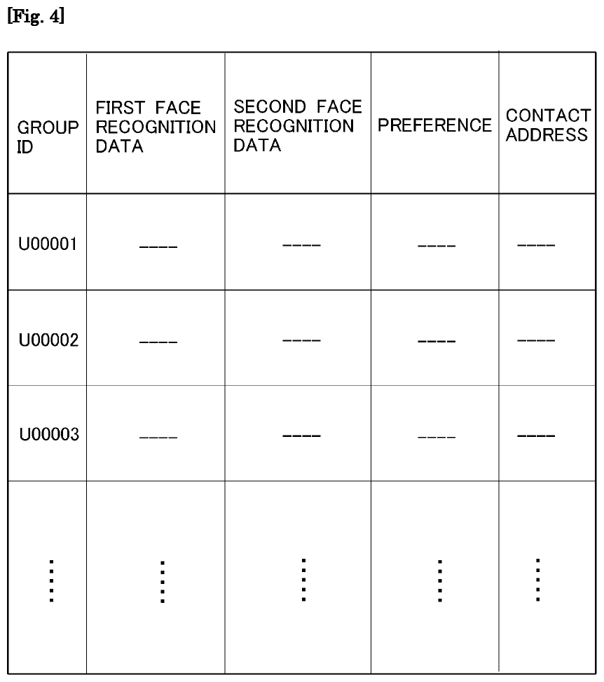

What is stored in the user management database 1031 is data that links the first user and the second user who accompanies the first user. An exemplary structure of data stored in the user management database 1031 will be described here with reference to FIG. 4. FIG. 4 illustrates an exemplary table structure of data stored in the user management database 1031. The table stored in the user management database 1031 will also be referred to as the “user information table” hereinafter. As illustrated in FIG. 4, the user information table has the fields of group ID, first face recognition data, second face recognition data, preferences, and contact address. What is stored in the group ID field is information (or a group ID) identifying each group including a first user and a second user who accompanies the first user. The group ID is assigned to each group, when each user information table is created in the user management database 1031. What is stored in the first face recognition data field is face recognition data for identifying the face of the first user. This data will also be referred to as “first face recognition data” hereinafter. What is stored in the second face recognition data field is face recognition data for identifying the face of the second user. This data will also be referred to as “second face recognition data” hereinafter. What is stored in the preferences field is information about an entertainment/entertainments that the first user likes. This information will also be referred to as “preferences information” hereinafter. Examples of the information stored in the preferences field include information about a certain character that the first user likes and information about a certain video game that the first user likes. What is stored in the contact address field is information about a contact address of the second user. In the system according to this embodiment, what is stored in the contact address field is information specifying the mail address of the user's terminal 400 that the second user carries.

The information stored in the first face recognition data field, the second face recognition data field, the preferences field, and the contact address field of the user information table may be entered to it at the time when the first user and the second user enter the specific area. The first face recognition data and the second face recognition data may be generated from an image captured by a camera 200 at the time when the first user and the second user enter the specific area. The preferences information of the first user and the information about the contact address of the second user may be entered into the server apparatus 100 by the second user through the user's terminal 400. The first face recognition data, the second face recognition data, the preferences information, and the information about the contact address may be entered into the server apparatus 100 by the second user in advance before the first user and the second user enter the specific area.

The user management database 1031 configured as above may be constructed by an external apparatus. In that case, the server apparatus 100 and the external apparatus may be connected via a network so that the server apparatus 100 can access the user management database 1031 when necessary.

Various processing executed by the server apparatus 100 configured as above may be executed by either hardware or software.

(Process Performed by Server Apparatus)

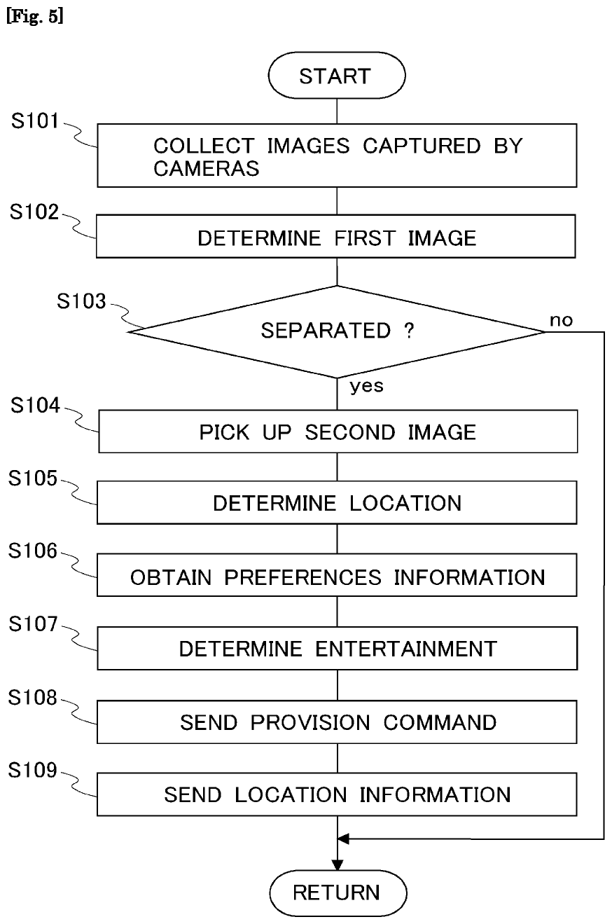

A process performed by the server apparatus 100 of this embodiment will now be described with reference to FIG. 5. FIG. 5 is a flow chart of a process executed repeatedly by the server apparatus 100. The process according to the flow chart of FIG. 5 is executed repeatedly for each of the groups (each of which includes a first user and a second user associated with each other) registered in the user management database 1031 in the storage unit 103.

In the processing routine according to the flow chart of FIG. 5, the detection part 1021 of the server apparatus 100 collects images captured by the cameras 200 through the communication unit 101 (step S101). Then, the detection part 1021 determines an image in which the second user appears (i.e. the first image) from among the images collected in step S101 (step S102). Specifically, the detection part 1021 firstly accesses the user information table of the user management database 1031 to read out the second face recognition data stored in the second face recognition data field. Then, the detection part 1021 compares each of the images collected in step S101 with the second face recognition data to pick up an image in which a face that matches the second face recognition data appears. Thus, the detection part selects the image picked up in this way as the first image.

The detection part 1021 determines whether the first user and the second user have been separated from each other on the basis of the first image determined in step S102 (step S103). Specifically, the detection part 1021 picks up the first image and an image/images (or related image/images) obtained by capturing a region/regions adjacent to the subject region of the first image from among the images collected in step S101. Then, the detection part 1021 crops an image of the area within the predetermined distance from the second user out of the first image and the related image/images. Moreover, the detection part 1021 reads out the first face recognition data stored in the first face recognition data field of the user information table from which the second face recognition data was read out in step S102. Then, the detection part 1021 compares the aforementioned cropped-out image with the first face recognition data to determine whether there is a face that matches the first face recognition data in the cropped-out image. If there is a face that matches the first face recognition data in the cropped-out image, it means that the first user is present within the predetermined distance from the second user. Then, the detection part 1021 determines that the first user and the second user have not been separated (a negative determination in step S103). Then, this processing routine is terminated this time. On the other hand, if there is not a face that matches the first face recognition data in the cropped-out image, it means that the first user is not present within the predetermined distance from the second user. Then, the detection part 1021 determines that the first user and the second user have been separated (an affirmative determination in step S103). Then, the processing of steps S104 to S109 is executed subsequently.

As described above, the detection part 1021 may determine that the first user and the second user have been separated (to become lost to each other), when the absence of a face that matches the first face recognition data in the cropped-out image continues longer than a predetermined length of time. This can prevent the detection part 1021 from determining that the first user and the second user have been separated in the case where the first user and the second user temporarily separate from each other by a distance larger than the predetermined distance intentionally with mutual consent.

In step S104, the determination part 1022 of the server apparatus 100 picks up an image in which the first user appears (i.e. second image) from among images collected in step S101. Specifically, the determination part 1022 compares each of the images collected in step S101 with the first face recognition data read out in step S103 to pick up an image in which a face that matches the first face recognition data appears. Thus, the detection part selects this picked-up image as the second image.

In step S105, the determination part 1022 determines the location of the first user on the basis of the second image picked up in step S104. Specifically, the determination part 1022 determines the region in which the camera 200 that captured the second image (i.e. the subject region of the second image) as the location of the first user. The determination part 1022 sends information about the location of the first user thus determined to the providing part 1023.

In step S106, the providing part 1023 of the server apparatus 100 obtains the preferences information of the first user. Specifically, the providing part 1023 reads out the preferences information stored in the preferences field of the user information table from which the first face recognition data was read out in step S103.

In step S107, the providing part 1023 determines an entertainment to be provided to the first user. Specifically, the providing part 1023 determines the entertainment to be provided to the first user on the basis of the preferences information read out in step S106. For example, if the preferences information of the first user indicates a certain character of an animation or the like, the providing part 1023 determines an animation video in which that character appears as the entertainment to be provided to the first user. If the preferences information of the first user indicates a certain video game, the providing part 1023 determines this video game as the entertainment to be provided to the first user.

In step S108, the providing part 1023 sends a provision command to a signage apparatus 300 provided in the region determined in step S105 (i.e. the region in which the determined location of the first user falls). The provision command is a command for providing the entertainment determined in step S107 to the first user. If the entertainment determined in step S107 is an animation video, the provision command is a command for causing the signage apparatus 300 to output this video. In that case, the provision command may contain data of this video. If the entertainment determined in step S107 is a video game, the provision command is a command for causing the signage apparatus 300 to execute the software of this video game. In that case, the provision command may contain the software of this video game. The signage apparatus 300 receives the provision command described above and outputs the video in which the character the first user likes appears or executes the software of the video game that the first user like. This can bring the first user's attention to the signage apparatus 300. In consequence, it is possible to prevent the first user from moving from the region determined in step S105 to another region. In other words, it is possible to make the first user stay in the region determined in step S105.

The provision command may include a command for causing the signage apparatus 300 to output a message requesting the first user to stay at the determined location until the second user comes to meet the first user. If this message is output from the signage apparatus 300, it is possible to prevent the first user from moving from the region determined in step S105 to another region with improve reliability.

In step S109, the informing part 1024 of the server apparatus 100 sends information indicating the determined location of the first user (or location information) to the user's terminal 400 of the second user. Specifically, the informing part 1024 firstly reads out the information stored in the contact address field of the user information table from which the second face recognition data was read out in step S102, namely the mail address of the user's terminal 400. Then, the informing part 1024 sends the location information of the first user to this mail address through the communication unit 101. The user's terminal 400 receives this location information and outputs the information indicating the determined location of the first user (i.e. information indicating the region in which the first user is located) through its display or speaker. The location information sent from the server apparatus 100 to the user's terminal 400 may contain map data indicating a path from the region in which the second user is located to the region in which the first user is located and/or an image obtained by capturing the first user. The image of the first user contained in the location information may be either the second image picked up in step S104 or an image captured by a camera that the signage apparatus 300 has. This enables the second user to come to the determined location of the first user quickly and/or to see the present situation of the first user.

When the first user is separated from the second user to become lost in the specific area, the process according to the flow chart of FIG. 5 can determine the location of the first user quickly and efficiently. Moreover, the process according to the flow chart of FIG. 5 provides an entertainment that meets the preferences of the first user at the determined location of the first user, so that is it possible to make the first user stay at the determined location. In consequence, it is possible to prevent the first user from moving from the determined location before the second user comes to meet the first user. Thus, the process according to the flow chart of FIG. 5 enables the first user and the second user to meet again efficiently.

### <First Modification>

While a case where an entertainment is provided to the first user using the signage apparatus 300 has been described in the above description of the embodiment, an entertainment may be provided to the first user using an autonomously movable robot imitating an animal or a character. In that case, what is stored in the preferences field of the user information table may be information specifying an animal or a character that the first user likes. When determining an entertainment to be provided to the first user, the providing part 1023 may select a robot on the basis of the preferences information of the first user. For example, if the preferences information of the first user specifies a certain animal, the providing part 1023 selects a robot imitating that animal. Then, the providing part 1023 creates an operation command for causing the selected robot to move autonomously to the determined location of the first user. This operation command includes, for example, a command for causing the robot to move autonomously to the determined location of the first user and a command for causing the robot to play with the first user at the determined location of the first user. The operation command is sent from the server apparatus 100 to the robot through the communication unit 101.

The robot receives the operation command and operates pursuant to the operation command to move to the determined location of the first user. Then, the robot plays with the first user at the determined location of the first user. Thus, it is possible to make the first user stay at the determined location.

In the case where the aforementioned robot has micro-mobility, the providing part 1023 may create an operation command including the following first to third commands and send it to the robot.

first command: a command for causing the robot to move autonomously to the determined location of the first user

second command: a command for causing the robot to pick up the first user at the determined location of the first user

third command: a command for causing the robot to move autonomously from the determined location of the first user to the location of the second user

In this case, while it is not possible to make the first user stay at the determined location, it is possible to prevent the first user from moving uselessly and to enable the first user and the second user to meet efficiently.

### <Second Modification>

While a case where the location information of the first user is provided to the second user through the user's terminal 400 has been described in the above description of the embodiment, the location information of the first user may be presented to the second user by the signage apparatus 300 located closest to the second user.

When providing the location information of the first user to the second user, the informing part 1024 of the second modification firstly determines the location of the second user. Specifically, the informing part 1024 may determine the region in which the camera 200 that captured the aforementioned first image (i.e. the subject region of the first image) as the determined location of the second user. Then, the informing part 1024 may cause a signage apparatus 300 provided in the region determined as above to display the location information of the first user. Thus, it is possible to provide the location information of the first user to the second user, even if the second user does not carry the user's terminal 400, or if the contact address of the user's terminal 400 is unknown.

The location information of the first user may be not only displayed on the signage apparatus 300 located closest to the second user but also sent to the user's terminal 400 of the second user. This enables the location information of the first user to be provided to the second user whether the second user carries the user's terminal 400 or not.

### <Third Modification>

While a case where separation of the first user and the second user is detected based on an image captured by a camera 200 has been described in the above description of the embodiment, separation of the first user and the second user may be detected based on a request made by the second user.

In the system according to the third modification, the second user makes a search request to the server apparatus 100 through the user's terminal 400 or the signage apparatus 300 located closest to the second user. The search request is a request for search for the first user who has been separated from the second user to become lost. The search request contains, for example, the group ID assigned to the second user and the first user or an image of the face of the second user. The image of the face of the second user may be an image captured by the user's terminal 400 or an image captured by the camera that the signage apparatus 300 has.

When the server apparatus 100 receives the search request, the detection part 1021 thereof accesses the user management database 1031 to find the user information table in which the first user and the second user are linked. In the case where the search request contains the group ID, the detection part 1021 may find the user information table in which information same as this group ID is stored in its group ID field from among the user information tables stored in the user management database 1031. In the case where the search request contains an image of the face of the second user, the detection part 1021 may find the user information table in which face recognition data that matches this image of the face of the second user is stored in the second face recognition data field from among the user information tables stored in the user management database 1031. After the user information table is found in this way, the location of the first user may be determined, an entertainment may be provided to the first user, and the location information may be provided to the second user, in the same way as the above-described embodiment.

### <Others>

The above embodiment and modification have been described only by way of example. Modifications can be made to them without departing from the essence of this disclosure. For example, the processing performed by the server apparatus 100 may be performed partly or entirely by the user's terminal 400. Specifically, only the processing for providing an entertainment to the first user may be executed by the server apparatus 100, and the other processing may be executed by the user's terminal 400. Alternatively, the processing for providing an entertainment to the first user and the processing that tends to require high computational load (e.g. the processing of comparing images captured by the cameras 200 and the first face recognition data) may be executed by the server apparatus 100, and the other processing may be executed by the user's terminal 400.

The processes that have been described in this disclosure may be employed in any combination so long as it is technically feasible to do so. For example, features of the above-described embodiment and the first to third modifications may be employed in any feasible combination. One, some, or all of the processes that have been described as processes performed by one apparatus may be performed by a plurality of apparatuses in a distributed manner. One, some, or all of the processes that have been described as processes performed by different apparatuses may be performed by a single apparatus. The hardware configuration employed to implement various functions in a computer system may be modified flexibly.

The technology disclosed herein can be carried out by supplying a computer program(s) (or information processing program) that implements the functions described in the above description of the embodiment to a computer to cause one or more processors of the computer to read and execute the program(s). Such a computer program(s) may be supplied to the computer by a computer-readable, non-transitory storage medium that can be connected to a system bus of the computer, or through a network. The computer-readable, non-transitory storage medium refers to a recording medium that can store information, such as data and programs, electrically, magnetically, optically, mechanically, or chemically in such a way as to allow the computer or the like to read the stored information. Examples of the computer-readable, non-transitory storage medium include any type of disc medium including a magnetic disc, such as a floppy disc (registered trademark) and a hard disk drive (HDD), and an optical disc, such as a CD-ROM, a DVD and a Blu-ray disc. The computer-readable, non-transitory storage medium may include other storage media, such as a read-only memory (ROM), a random access memory (RAM), an EPROM, an EEPROM, a magnetic card, a flash memory, an optical card, and a solid state drive (SSD).

What is claimed is:

1. An information processing system comprising:
a plurality of cameras provided in a specific area;
a storage device that stores data that links a first user and a second user accompanying the first user who are in the specific area;
a controller including at least one processor and executing the processing of detecting that the first user and the second user have been separated to become lost to each other, determining the location of the first user using images captured by the plurality of cameras and data stored in the storage device, providing an entertainment to the first user at the location determined by the above processing, and providing location information to the second user, the location information being information about the location determined by the above processing.

2. An information processing system according to claim 1, wherein in the processing of providing an entertainment to the first user, the controller causes a signage apparatus provided near the determined location of the first user to output a digital content that meets preferences of the first user.

3. An information processing system according to claim 1, wherein in the processing of providing an entertainment to the first user, the controller causes an autonomously-movable play machine to move to the determined location of the first user.

4. An information processing system according to claim 1, wherein in the processing of providing the location information to the second user, the controller provides to the second user an image in which the first user to which the entertainment is being provided appears among images captured by the plurality of cameras together with the location information.

5. An information processing system according to claim 1, wherein in the processing of detecting that the first user and the second user have been separated to become lost to each other, the controller detects that the first user is not present within a predetermined distance from the second user on the basis of images captured by the plurality of cameras.

6. An information processing system according to claim 1, wherein in the processing of detecting that the first user and the second user have been separated to become lost to each other, the controller detects the absence of the first user within a predetermined distance from the second user that continues for longer than a predetermined length of time on the basis of images captured by the plurality of cameras.

7. An information processing system according to claim 1, wherein in the processing of detecting that the first user and the second user have been separated to become lost to each other, the controller receives a request for search for the first user from the second user.

8. An information processing system according to claim 1, wherein the storage device stores data that links face recognition data of the first user and face recognition data of the second user.

9. An information processing system according to claim 8, in the processing of determining the location of the first user, the controller determines the location of the first user on the basis of the face recognition data of the first user stored in the storage device and images captured by the plurality of cameras.

10. An information processing system according to claim 8, wherein the storage device stores data that further links information about preferences of the first user with the face recognition data of the first user and the face recognition data of the second user, and in the processing of providing an entertainment to the first user, the controller determines an entertainment to be provided to the first user on the basis of the information about the preferences of the first user.

11. An information processing apparatus comprising:
a storage device that stores data that links a first user and a second user accompanying the first user who are in a specific area;
a controller including at least one processor and executing the processing of detecting that the first user and the second user have been separated to become lost to each other, determining the location of the first user using images captured by a plurality of cameras provided in the specific area and data stored in the storage device, providing an entertainment to the first user at the location determined by the above processing, and providing location information to the second user, the location information being information about the location determined by the above processing.

12. An information processing apparatus according to claim 11, wherein in the processing of providing an entertainment to the first user, the controller causes a signage apparatus provided near the determined location of the first user to output a digital content that meets preferences of the first user.

13. An information processing apparatus according to claim 11, wherein in the processing of providing an entertainment to the first user, the controller causes an autonomously-movable play machine to move to the determined location of the first user.

14. An information processing apparatus according to claim 11, wherein in the processing of providing the location information to the second user, the controller provides to the second user an image in which the first user to which the entertainment is being provided appears among images captured by the plurality of cameras together with the location information.

15. An information processing apparatus according to claim 11, wherein in the processing of detecting that the first user and the second user have been separated to become lost to each other, the controller detects that the first user is not present within a predetermined distance from the second user on the basis of images captured by the plurality of cameras.

16. An information processing apparatus according to claim 11, wherein in the processing of detecting that the first user and the second user have been separated to become lost to each other, the controller detects the absence of the first user within a predetermined distance from the second user that continues for longer than a predetermined length of time on the basis of images captured by the plurality of cameras.

17. An information processing apparatus according to claim 11, wherein in the processing of detecting that the first user and the second user have been separated to become lost to each other, the controller receives a request for search for the first user from the second user.

18. An information processing apparatus according to claim 11, wherein the storage device stores data that links face recognition data of the first user and face recognition data of the second user.

19. An information processing system according to claim 18, wherein the storage device stores data that further links information about preferences of the first user with the face recognition data of the first user and the face recognition data of the second user, and in the processing of providing an entertainment to the first user, the controller determines an entertainment to be provided to the first user on the basis of the information about the preferences of the first user.

20. An information processing method comprising the following steps of processing executed by a computer:
detecting that a first user and a second user accompanying the first user who are in a specific area have been separated to become lost to each other;
obtaining data that links the first user and the second user;
determining the location of the first user using images captured by a plurality of cameras provided in the specific area and the data that links the first user and the second user;
providing an entertainment to the first user at the location determined in the above step; and
providing location information to the second user, the location information being information about the location determined in the above step.
